(19) United States
(12) Patent Application Publication
(10) Pub. No.: US 2010/0084381 A1
(43) Pub. Date: Apr. 8, 2010

(54) PROCESS FOR THE PLASMA SPOT WELDING OF SURFACE-TREATED WORKPIECES AND PLASMA TORCH

(75) Inventors: Reinhard Indraczek, Wullersdorf (AT); Ferdinand Stempfer, Aspersdorf (AT)

Correspondence Address: Workman Nydegger;1000 Eagle Gate Tower, 60 East South Temple, Salt Lake City, UT, 84111, US

(73) Assignee: SBI PRODUKTION TECHN. ALAGEN GMBH, Hollabrunn (AT)

(21) Appl. No.: 12/522,727

(22) PCT Filed: Jan. 10, 2008
(86) PCT No.: PCT/AT2008/000006

§ 371 Date: Jul. 30, 2009

(30) Foreign Application Priority Data
Jan. 11, 2007 (AT) A 59/2007

(51) Int. Cl. B23K 10/02; B23K 10/00

(52) U.S. Cl. 219/121.39; 219/121.46; 219/121.45

(57) ABSTRACT

A process for plasma spot welding of surface-treated workpieces using a plasma torch comprises supplying a plasma-generating gas to the plasma torch, connecting a first terminal (−) of a current source to an electrode of the plasma torch, connecting a second terminal (+) of the current source to a workpiece, building up at least one plasma arc from the electrode of the torch toward the workpiece by applying electric current (I(t)) from the current source to an anode-cathode path between the electrode and the workpiece. The electric current (I(t)) is kept in a preprocessing current range (I_{V}) in a phase I and, in a subsequent phase II, at a main processing current value (I_{H}) having an the average value of which is higher than the average preprocessing current range (I_{V}). Phase I is maintained at least until the at least partial evaporation of surface treatment layers of the workpieces in a joining zone.

The invention concerns a process for the plasma spot welding of surface-treated workpieces using a plasma torch, according to the preamble of claim 1.

Furthermore, the invention concerns a plasma torch for welding and cutting workpieces, according to the preamble of claim 12.

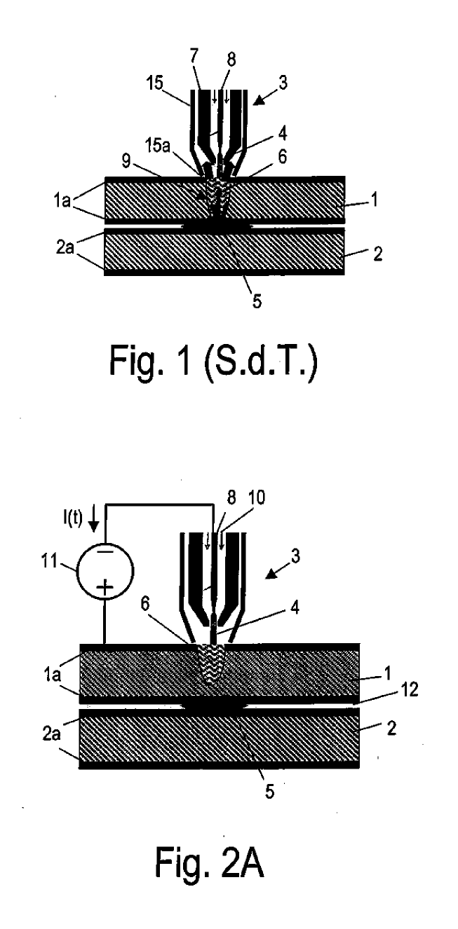

While the plasma spot welding of uncoated metal sheets in the lap joint is already technologically controllable and produces satisfactory welding spots of adequate strengths, see e.g. EP 1 168 896 A2, the required process stability has so far not existed in surface-treated and/or coated, in particular galvanized, metal sheets. The reason for this is the explosive evaporation of the zinc layers, which occurs during the thorough melting of the metal sheets, and the ejection of melt associated therewith, which reaches also the interior of the torch and hence destroys the torch, as illustrated in FIG. 1. FIG. 1 shows a lap joint made of two metal sheets 1, 2, each of them being provided with zinc layers 1a, 2a on their two surfaces. In the torch 3, a plasma arc 4 of a high temperature is generated, which causes the metal sheet 1 to melt thoroughly within a short period of time, whereby the zinc layers 1a evaporate. The zinc vapour 5 escapes through the through hole 9 formed in the first metal sheet and, in doing so, it carries away melt 6 present in the through hole 9, among other things, into the interior of the torch 3. In addition to the defective welding spot created thereby, the plasma nozzle 7 and the tungsten electrode 8 of the torch 3 are almost always rendered unusable by splashes of melt 6 hurled into the torch 3, which necessitate an expensive cleaning and repair of the torch.

From DE 41 29 247 A1 and DE 42 33 818 A1, protective gas welding methods are known in which electrodes are melted off for producing the welded joint or, in other words, a material supply to the welding point takes place. The current supply occurs according to a predetermined current profile in order to either prevent the detachment of melt drops from the electrodes or at least control it in such a way that only small melt drops will squirt off.

It is therefore the object of the invention to provide a process for the plasma spot welding of surface-treated workpieces using a plasma torch as well as a plasma torch which overcome the disadvantages of the prior art and enable a reliable, firm and optically perfect plasma spot welding connection of surface-coated workpieces such as galvanized metal sheets.

Said object is achieved by a plasma spot welding process having the characterizing features of claim 1 and a plasma torch having the characterizing features of claim 12. Advantageous embodiments of the invention are set forth in the dependent claims.

The process according to the invention for the plasma spot welding of surface-treated workpieces using a plasma torch comprises supplying a plasma-generating gas to the plasma torch, connecting a first terminal of a current source to an electrode of the plasma torch, connecting a second terminal of the current source to a workpiece to be welded, and building up at least one plasma arc from the electrode of the torch toward the workpiece by applying electric current from the current source to an anode-cathode path between the electrode and the workpiece. In a phase I, the electric current is kept in a preprocessing current range. In a subsequent phase II, the electric current is kept at a main processing current value or range the average value of which is higher than the average preprocessing current range. Optionally, the electric current is reduced in a subsequent phase III. In order to achieve high-strength welded joints, phase I is maintained at least until the at least partial evaporation of surface treatment layers of the workpieces in a joining zone between the two workpieces.

The solution according to the invention is based on a technology which enables evaporation of the surface treatment layers (zinc layers) in a joining zone between workpieces (metal sheets), without the workpiece (metal sheet) itself already having changed into the molten state, making use of the temperature difference between the melting point of the workpiece, e.g., of a sheet metal material (approx. 1450° C.), and the evaporation temperature of the surface finish of the workpiece, e.g., a zinc coating (906° C.). The processes proceeding therein are implemented in a multiphase technology, particularly a threephase technology.

In one embodiment of the plasma spot welding process according to the invention, the electric current is thereby kept constant in phase I after having been switched on, wherein the current has a relatively low value in order to allow—by heating the uppermost piece from a stack of workpieces with the plasma arc in such a controlled manner—the surface finish located on the bottom side of the workpiece to evaporate in the joining zone as a result of heat conduction, whereby the metal sheet is not yet thoroughly melted during phase I. In other words, the difference between the melting temperature of the workpiece and the evaporation temperature of the surface finish is utilized.

The same effect can also be achieved by an alternative embodiment of the plasma spot welding process according to the invention by increasing the electric current in a ramp-shaped (up-slope) or gradual manner in phase I until the current value reaches a value of the main processing current value at the transition to phase II. In doing so, it is desirable that the workpiece is not heated too quickly. In order to ensure this, in a preferred embodiment, the gradient of the ramp-shaped current increase is determined according to the inequality 0<dI/dt<1000 in [A/s].

In alternative embodiments, the current rises have pulsed, swelling or parabolic progressions.

For the same reason, phase II (main processing) should be maintained at least until the formation of a tap hole in the workpiece facing the plasma torch by melting completely through said workpiece.

In order that the tap hole formed through the workpieces to be connected in the main processing phase II recloses, it is advantageous if the electric current is reduced in a ramp-shaped (down-slope) or gradual manner in phase III. For achieving a processing speed which is as high as possible, it is preferred that the slope (−dI/dt) of the ramp-shaped current reduction is larger than 100.

For a controlled closure of the tap hole by the solidifying melt, it is advantageous if phase III is maintained at least until the formation of a tap hole passing through all workpieces to be joined together by melting completely through all workpieces and subsequently reclosing the tap hole by solidifying the melt present in the tap hole as a result of the reduced current supply.

In order that smokes and gases escaping from the tap hole on the side of the plasma torch do not carry melt along with them into the torch during the welding process, in one advanced embodiment of the plasma spot welding process according to the invention, it is intended to guide said smokes and gases laterally from the plasma torch at a distance from the surface of the workpiece.

In order to be able to determine precisely at which point in time the tap hole has formed through all workpieces to be connected, it is intended that a gas pressure measurement is performed on the torch tip, particularly in the inner gas flow channel of the plasma torch, whereby the complete formation of the tap hole through all workpieces is detected from a pressure drop in the welding chamber and the end of phase II can be determined therefrom.

The invention also provides a plasma torch which is suitable for implementing the process according to the invention. Said plasma torch for welding and cutting workpieces is provided with an electrode for connection to a first terminal of a current source, an electro conductive plasma nozzle surrounding the electrode at a distance, with an inner flow channel for plasma-generating gas being formed between the electrode and the plasma nozzle, and a support ring surrounding the plasma nozzle at a distance for attachment on the surface of a workpiece, the support ring exhibiting through openings distributed around its periphery and spaced apart from an attachment zone. As a result of this measure, smokes and gases can escape from the torch laterally, namely at an angle of approx. 90° or closer to the longitudinal axis of the torch, whereby it is avoided that the workpiece surface is impaired or that melt particles are hurled onto the sensitive electrode of the torch. For optimizing the flow path of the plasma-generating gas through the torch and in particular for gas focussing, a gas guiding sleeve is arranged between the plasma nozzle and the support ring, which gas guiding sleeve projects axially beyond the front end of the plasma nozzle, but is shorter than the support ring, wherein the gas guiding sleeve is spaced apart from the plasma nozzle and the support ring and thereby forms an outer flow channel for the plasma-generating gas between the plasma nozzle and the gas guiding sleeve.

From U.S. Pat. No. 1,743,070 A1 and DE 197 54 859 A1, plasma torches are known which, however, do not comprise a gas guiding sleeve.

In order to protect the electrode even better from contamination by melt particles and produce an optimum flow path for the smokes and gases escaping from evaporated surface coatings of workpieces subjected to the welding treatment, in one embodiment of the plasma torch according to the invention, it is intended that the support ring projects axially beyond the front end of the plasma nozzle and through holes extend in the wall region of the support ring between the front end of the plasma nozzle and the attachment zone of the support ring. The through holes may advantageously have a circular, elliptical or slit-shaped design, whereby the torch is easily manufacturable and gases and smokes can easily escape sideways.

In order that the gas guiding sleeve does not prevent the smokes and gases of the evaporated surface finish of the workpiece from escaping laterally from the torch, it is furthermore intended that through holes extend in the wall region of the support ring between the front end of the gas guiding sleeve and the front end of the support ring.

Furthermore, an electric insulator is provided between the gas guiding sleeve and the support ring.

For increasing the flow velocity of the plasma-generating gas in the outer flow channel, a web can be formed on the inner surface of the gas guiding sleeve for reducing the cross-sectional area of the outer flow channel.

In a preferred embodiment of the invention, the plasma torch is formed essentially from metal or a metal alloy.

For an improved control of the plasma torch, a pressure sensor is furthermore provided in the welding chamber of the plasma torch.

The invention is now illustrated further in a non-limiting manner on the basis of exemplary embodiments, with reference to the drawings.

In the figures:

FIG. 1 shows a sectional view of the development of defective welded joints during the plasma spot welding of galvanized metal sheets in the lap joint according to the prior art;

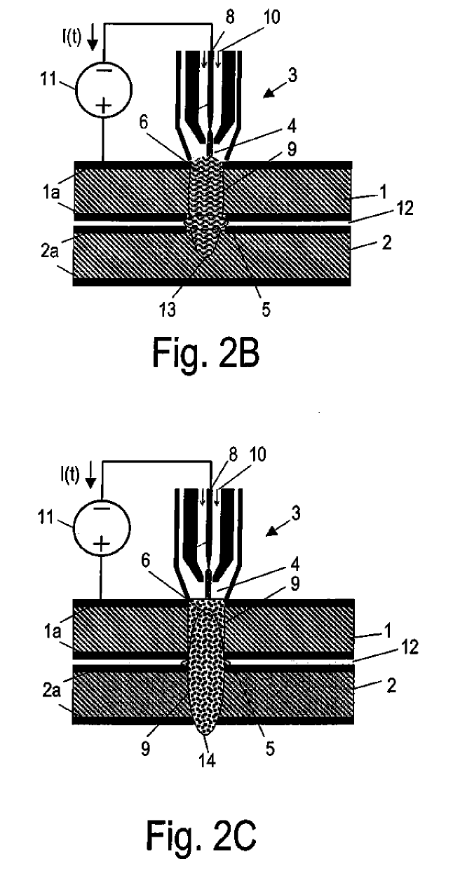

FIG. 2A shows a sectional view for illustrating a first phase of the plasma spot welding process according to the invention;

FIG. 2B shows a sectional view for illustrating a second phase of the plasma spot welding process according to the invention;

FIG. 2C shows a sectional view for illustrating a third phase of the plasma spot welding process according to the invention;

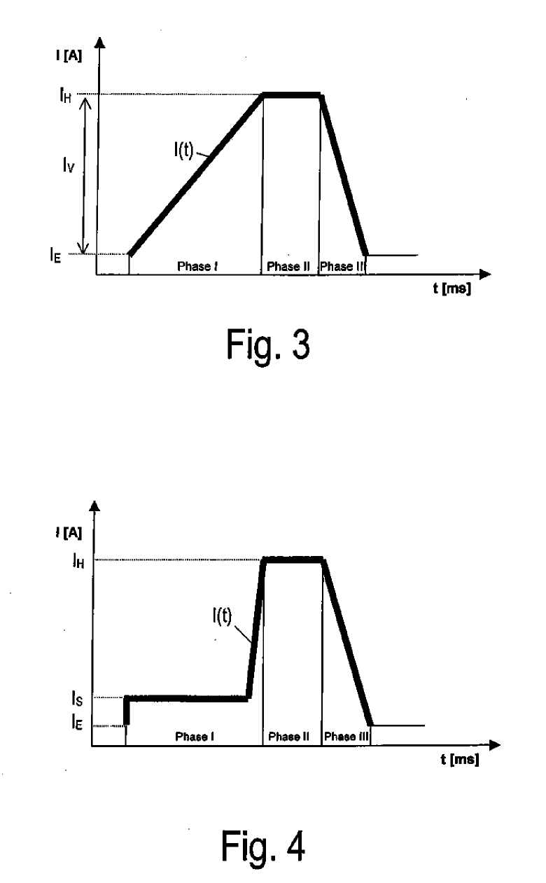

FIG. 3 shows a diagram of the progression of the plasma flow over time in one embodiment of the plasma spot welding process according to the invention;

FIG. 4 shows a diagram of the progression of the plasma flow over time in a further embodiment of the plasma spot welding process according to the invention; and

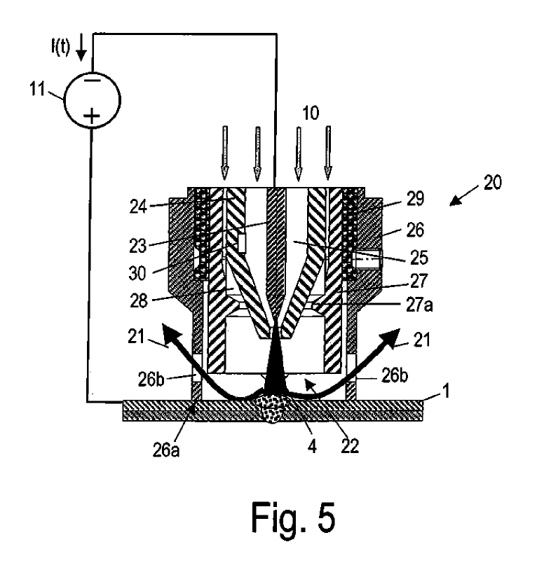

FIG. 5 shows a longitudinal section through a plasma torch according to the present invention.

At first, the process according to the invention for the plasma spot welding of a stack of surface-treated workpieces in the form of galvanized metal sheets 1, 2 using a previously known plasma torch 3, which has already been described above with reference to FIG. 1, is exemplified on the basis of FIGS. 2A to 2C.

A plasma-generating gas 10 or protective gas, respectively, e.g., argon, is supplied to the plasma torch 3. An electrode 8 of the plasma torch 3 is connected to a first terminal (−) of a current source 11, which is configured as a controlled direct-current source. A second terminal (+) of the current source 11 is connected to the upper metal sheet 1. A plasma arc 4 from the electrode 8 of the torch toward the metal sheet 1 is built up by applying electric current I(t) from the current source 11 to an anode-cathode path between the electrode 8 and the upper metal sheet 1, with the current I(t) being controlled according to a threephase process, as can be seen from the current-time diagrams of FIGS. 3 and 4. In a phase I, which is a preprocessing and/or preheating and evaporation phase, the electric current is first kept in a preprocessing current range I_{V}. In one embodiment of the process according to the invention, a current path increasing in the shape of a ramp (up-slope) is provided, which increases steadily from a switch-on value I_{E} to a main processing current value I_{H}, which marks the beginning of phase II, as can be seen in FIG. 3. Alternatively, as is illustrated in FIG. 4, the preprocessing current can first be kept at a constant, low value I_{S} after having been switched on and can be raised in a ramp-shaped manner to the main processing current value I_{H} range only toward the end of phase I, for which a steep rise of the current I(t) has here been selected. Alternatively, a stepped increase in the current I(t) is also possible, wherein, depending on the application, any combinations of a current which is constant (in sections) and a current path increasing in a ramp-shaped or cascaded manner are eligible within phase I.

The effect of the progression of the current I(t) in phase I and of the plasma arc 4 controlled according to the current path, respectively, is illustrated in FIG. 2A. The heating of the upper metal sheet 1 controlled by the plasma arc 4 propagates by heat conduction to the bottom side of the metal sheet 1 and causes the lower zinc layer 1a of the upper metal sheet 1 and the upper zinc layer 2a of the lower metal sheet 2 to evaporate in the joining zone 12 between the metal sheets 1 and 2, whereas, at this point in time, the upper metal sheet 1 and consequently also the lower metal sheet 2 have not yet thoroughly melted. In doing so, the difference between the melting temperature of the material of the metal sheet 1 and the lower evaporation temperature of the zinc coatings 1a, 2a is utilized. Since both metal sheets 1, 2 in the joining zone 12 have not yet melted, the zinc vapour 5 is circularly displaced into the gap between the metal sheets 1, 2, which always exists in reality. A largely zinc-free area emerges in the region of the joining zone 12.

When this state is reached, the electric current I(t) is kept in a subsequent phase II, the so-called full penetration welding phase, at a main processing current value I_{H} or in a main processing current range, respectively, the average value of which is higher than the average value of the current (increasing in a ramp-shaped and/or gradual manner) in phase I. As can be seen in the diagrams of FIGS. 3 and 4, a constant main processing current value I_{H} has been adjusted in those exemplary embodiments. As a result of further energy supply through the plasma arc 4, which is now operated at the high main processing current value I_{H}, the upper metal sheet 1 melts through completely, i.e., a through hole 9 forms in the upper metal sheet 1, see FIG. 2B. Zinc residues which at first still exist in the joining zone 12 directly in the area of the through hole 9 are largely dissolved in the melt 6 of the sheet metal material or, respectively, are pushed out of the joining zone 12 toward the welding spot root 13 by the kinetic energy of the plasma arc 4. The pressure exerted by the plasma arc 4 on the melt 6 causes the melt 6 to be pressed onto the lower metal sheet 2. The fusion and penetration process into the lower metal sheet 2 continues unhindered by zinc evaporation until a through hole 9 forms also in the lower metal sheet 2, see FIG. 2C.

At this point in time, phase II is finished. The plasma arc 4 completely penetrates both metal sheets 1, 2 and a so-called tap hole has formed, i.e., through holes 9 through both metal sheets 1, 2. In phase III, which now follows and is also referred to as the seam forming phase, the electric current I(t) and hence the energy of the plasma arc 4 are reduced, whereby, as can be seen in the diagrams of FIGS. 3 and 4, the current reduction proceeds in a ramp-shaped manner (down-slope) with a steep slope of clearly more than 1. Due to the reduction in the performance of the plasma arc 4 as well as the surface tension of the melt 6, the tap hole recloses as the melt 6 located therein solidifies, whereby a characteristic root of weld 14 forms on the bottom side of the lower metal sheet 2. The spot welded joint has been generated. An advantage of said process according to the invention is that access for the plasma torch only from one side of the stack of metal sheets 1, 2 is required.

As has been illustrated, in the plasma spot welding process according to the invention with threephase technology, the necessary controlled heating of the upper metal sheet is achieved in phase I by the up-slope of the current I(t). According to the sheet thicknesses to be connected and the different heat-physical properties of the materials to be welded, adapted progressions are necessary for the up-slope of the current in phase I (FIGS. 3 and 4).

The length of the plasma arc 4 which is required for a reproducible welding process and always stays the same is usually ensured by a spacer nozzle 15 which, at the same time, also serves for the supply of protective gas (see FIG. 1). It is known to provide this spacer nozzle 15 with recesses directly in the attachment zone 15a, which recesses allow the welding gases to flow out of the nozzle space. This is necessary since otherwise the overpressure forming within the nozzle would adversely affect the kinetic energy of the plasma arc 4 and reduce the welding depth. However, by guiding the welding gas flow in this manner, the surface of the parts to be welded, especially with galvanized deep-drawn metal sheets, is oxidized and contaminated by the hot welding gases in a relatively large area around the actual welding spot.

In order to eliminate this disadvantage and localize an oxidation and contamination around the welding spot as far as possible, a novel plasma torch 20 has been developed which restricts the contact of the welding gases 21 with the workpiece surface only to a minimal zone around the welding spot.

The plasma torch 20 is illustrated in FIG. 5 in longitudinal section. It comprises an electrode 23 for connection to a first terminal (−) of a current source 11, furthermore an electroconductive plasma nozzle 24 surrounding the electrode 23 at a distance, with an inner flow channel 25 for plasma-generating gas 10 being formed between the electrode 23 and the plasma nozzle 24, furthermore a support ring 26 surrounding the plasma nozzle 24 at a distance for attachment on the surface of a workpiece 1. It is essential that the support ring 26 exhibits through openings 26b distributed around its periphery through which the welding gases 21 can escape from the welding space 22 of the torch 20 while being deflected by 90° and more. However, in contrast to the prior art, the through openings 26b are not located directly on the attachment zone 26a of the support ring 26 (cf spacer nozzle 15 in FIG. 1), but axially spaced apart thereform, which contributes to the significantly improved deflection of the welding gases 21. The support ring 26 projects axially beyond the front end of the plasma nozzle 24, the through holes 26b extend in the wall region of the support ring 26 between the front end of the plasma nozzle 24 and the front end (attachment zone 26a) of the support ring 26 and may have, e.g., a circular, elliptical or slit-shaped design.

A further important feature of the plasma torch 20 according to the invention is that an annular gas guiding sleeve 27 is provided between the plasma nozzle 24 and the support ring 26, wherein the gas guiding sleeve 27 projects axially beyond the front end of the plasma nozzle 24, but is shorter than the support ring, i.e., ends behind the attachment zone 26a of the support ring 26. The gas guiding sleeve 27 is radially spaced apart from the plasma nozzle 24 and the support ring 26 and thereby forms an outer flow channel 28 for the plasma-generating gas 10. Furthermore, the length of the gas guiding sleeve 27 is chosen such that through holes 26b extend in the wall region of the support ring 26 between the front end of the gas guiding sleeve 27 and the front end (attachment zone 26a) of the support ring 26 in order to enable a favourable guidance of the welding gases 21. An electric insulator 29 is provided between the gas guiding sleeve 27 and the support ring 26. Furthermore, a web 27a is formed on the inner surface of the gas guiding sleeve 27 for reducing the cross-sectional area of the outer flow channel 28, whereby higher gas flow velocities are achieved in said area.

Except for the insulator 29, the components of the plasma torch 20 are preferably formed from metal or a metal alloy.

In an advanced embodiment of the plasma torch 20 according to the invention, a pressure sensor 30 is provided in the inner flow channel 25 directly on the torch tip or not far from it in order to measure the pressure in the welding chamber 22 of the plasma torch 20 and utilize the measured values for controlling the current supply to the plasma torch 20.

The gas guiding sleeve 27 in the interior of the torch should have such a length that the plasma arc 4 is guided almost to the surface of the workpiece 1. Said gas guiding sleeve 27 makes sure that the plasma arc 4 does not contact the workpiece surface more than necessary with its outer edge. The through holes 26b provided in the support ring 26 for discharging the welding gases 21 are attached such that, during welding, the hot welding gases do not contact the workpiece surface outside of the support ring 26, which means that they have to be formed at a distance from the attachment zone 26a of the support ring. The welding gases 21 are thereby deflected by more than 90° directly above the welding spot and flow unhindered from the welding chamber 22. The contact zone of the welding gases 21 on the workpiece 1 is restricted to an area which is not larger than that of the open end of the gas guiding sleeve 27 on the face side.

In summary, the present invention exhibits the following primary features and advantages:
Depending on the workpiece thicknesses to be welded and the heat-physical properties of the workpiece materials as well as the surface treatment (galvanization), a temporally and energetically controlled up-slope occurs in a phase I.
The current path is adjusted such that the plasma arc finally penetrates all workpieces to be welded so that a tap hole is formed during the welding process which is reclosed at the end of the welding process.
The formation of the tap hole is a criterion for a secure welded joint between the workpieces.
By appropriately constructing the plasma torch according to the invention, the plasma arc is guided in a gas guiding sleeve 27 until narrowly above the workpiece surface and localized within the plasma torch 20, whereby a reduced thermal damage to the workpiece surface is achieved.
The arrangement of the through holes 26b in the support ring 26 for discharging the welding gases 21 is clearly above the attachment zone 26a of the support ring 26. A restriction of the zone influenced by the welding process to the workpiece area located within the gas guiding sleeve 27 is thereby achieved.
Because of the constructive features of the plasma torch according to the invention, the consumption of protective or plasma generating gas 10, respectively, can be reduced (at least by 50% of the consumption which is otherwise required for classical plasma welding).

Tests conducted with the plasma spot welding process according to the invention and the plasma torch according to the invention have shown that, seen in terms of equipment technology and practical application, said plasma spot welding is currently suitable at least for workpieces having a total thickness of 5 mm. In the lower thickness range, the feasibility limit could be very small total sheet thicknesses of approx. 0.2 millimeters. However, those values are not to be regarded as absolute limiting values, in fact, they reflect only the previous tests of the inventors which have focussed on sheet thicknesses common in automobile manufacture.

In the following table, typical welding parameters for the plasma spot welding according to the invention of higher-strength galvanized metal sheets of various thicknesses from ZstE 340+Z 100 MB are indicated, wherein a plasma torch with a plasma nozzle having a diameter of 2.0 mm, a plasma gas supply of 0.81 l/min and a protective gas supply of 3 l/min have been adjusted. In phase I, a ramp-shaped increase (up-slope) of the current up to a main processing current value of 140 A has been adjusted, which has been maintained steadily in phase II:

| Sheet thickness | Phase I | Phase II |
|---|---|---|
| combination | UP-slope [ms] | Holding time [ms] |
| 1.0/1.0 mm | 1,400 | 200 |
| 1.0/1.2 mm | 1,800 | 200 |
| 1.0/1.5 mm | 1,800 | 400 |
| 1.2/1.0 mm | 1,800 | 400 |
| 1.2/1.2 mm | 1,800 | 600 |
| 1.2/1.5 mm | 1,800 | 800 |
| 1.5/1.0 mm | 1,800 | 600 |
| 1.5/1.2 mm | 1,800 | 800 |
| 1.5/1.5 mm | 1,800 | 1,000 |

1. A process for the plasma spot welding of surface-treated workpieces using a plasma torch, comprising:
supplying a plasma-generating gas to the plasma torch,
connecting a first terminal (−) of a current source to an electrode of the plasma torch,
connecting a second terminal (+) of the current source to a workpiece to be welded,
building up at least one plasma arc from the electrode of the torch toward the workpiece by applying electric current (I(t)) from the current source to an anode-cathode path between the electrode and the workpiece, wherein:
the electric current is kept in a preprocessing current range (I_{V}) in a phase I, and
in a subsequent phase II, the electric current (I(t)) is kept at a main processing current value (I_{H}) or range the average value of which is higher than the average preprocessing current range (I_{V}).

2. A plasma spot welding process according to claim 1, wherein the electric current (I(t)) is kept constant in phase I after having been switched on.

3. A plasma spot welding process according to claim 1, wherein the electric current (I(t)) is increased in a ramp-shaped (up-slope) or gradual manner in phase I.

4. A plasma spot welding process according to claim 1, wherein the electric current (I(t)) has a pulsed, swelling or parabolic progression in phase I.

5. A plasma spot welding process according to claim 3, wherein the gradient of the ramp-shaped current increase is determined according to the inequality:
0<dI/dt<1000 in [A/s].

6. A plasma spot welding process according to claim 20, wherein the electric current (I(t)) is reduced in a ramp-shaped (down-slope) or gradual manner in phase III.

7. A plasma spot welding process according to claim 1, wherein the slope (−dI/dt) of the ramp-shaped current reduction is larger than 100.

8. A plasma spot welding process according to claim 1, wherein phase II is maintained at least until the formation of a tap hole in the workpiece facing the plasma torch by melting completely through said workpiece.

9. A plasma spot welding process according to claim 20, wherein phase III is maintained at least until the formation of a tap hole passing through all workpieces to be joined together by melting completely through all workpieces and subsequently reclosing the tap hole by solidifying the melt present in the tap hole as a result of the reduced current supply.

10. A plasma spot welding process according to claim 1, wherein smokes and gases escaping from the tap hole on the side of the plasma torch are guided laterally from the plasma torch at a distance from the surface of the workpiece.

11. A plasma spot welding process according to claim 1, wherein a gas pressure measurement is performed in the welding chamber of the plasma torch, whereby the complete formation of the tap hole through all workpieces is detected from a pressure drop in the welding chamber, from which the end of phase II can be determined.

12. A plasma torch for welding and cutting workpieces, comprising:
an electrode for connection to a first terminal of a current source,
an electroconductive plasma nozzle surrounding the electrode at a distance, with an inner flow channel for plasma-generating gas being formed between the electrode and the plasma nozzle, and
a support ring surrounding the plasma nozzle at a distance for attachment on the surface of a workpiece, the support ring exhibiting through openings distributed around its periphery and spaced apart from an attachment zone, wherein:
a gas guiding sleeve is arranged between the plasma nozzle and the support ring, which gas guiding sleeve projects axially beyond the front end of the plasma nozzle, but is shorter than the support ring, and
the gas guiding sleeve is spaced apart from the plasma nozzle and the support ring and thereby forms an outer flow channel for the plasma-generating gas or protective gas, respectively, between the plasma nozzle and the gas guiding sleeve.

13. A plasma torch according to claim 12, wherein through holes extend in the wall region of the support ring between the front end of the gas guiding sleeve and the attachment zone of the support ring.

14. A plasma torch according to claim 12, wherein an electric insulator is provided between the gas guiding sleeve and the support ring.

15. A plasma torch according to claim 12, wherein a web is formed on the inner surface of the gas guiding sleeve for reducing the cross-sectional area of the outer flow channel.

16. A plasma torch according to claim 12, wherein the support ring projects axially beyond the front end of the plasma nozzle and through holes extend in the wall region of the support ring between the front end of the plasma nozzle and the attachment zone of the support ring.

17. A plasma torch according to claim 12, wherein the through holes have a circular, elliptical or slit-shaped design.

18. A plasma torch according to claim 12, wherein the plasma torch is formed essentially from metal or a metal alloy.

19. A plasma torch according to claim 12, further comprising a pressure sensor on the torch tip, particularly in the inner gas flow channel of the plasma torch.

20. A plasma spot welding process according to claim 1, wherein the electric current (I(t)) is reduced in a subsequent phase III, wherein phase I is maintained at least until the at least partial evaporation of surface treatment layers of the workpieces in a joining zone between the two workpieces.
